(19) United States
(12) Patent Application Publication
(10) Pub. No.: US 2016/0241987 A1
(43) Pub. Date: Aug. 18, 2016

(54) AN OPERATION AND MANAGEMENT SYSTEM FOR E-COMMERCE APPLICATION ON MOBILE DEVICE, METHOD THEROF, AND APPLICATION GERNERATOR

(71) Applicants: Edwin LIU, Taipei City (TW); NN HOLDINGS (TAIWAN). INC., Taipei City (TW)

(72) Inventors: KUEN-MOU LEE, Taipei City (TW); CHIEN-CHANG LEE, Taipei City (TW); TA-WEI LIN, Taipei City (TW); CHAO-CHI LEE, Taipei City (TW); HUI-FEN FANG, Taipei City (TW); CHIH-HUNG LIN, Taipei City (TW); WEI-WEI CHEN, Taipei City (TW)

(21) Appl. No.: 15/025,868

(22) PCT Filed: Oct. 9, 2014
(86) PCT No.: PCT/US14/59975

§ 371 Date: Mar. 29, 2016

(30) Foreign Application Priority Data
Oct. 11, 2013 (TW) 102218992
Dec. 4, 2013 (TW) 102222742

(51) Int. Cl. H04W 4/00; G06Q 30/06; G06F 9/44; H04L 29/08

(52) U.S. Cl. CPC H04W 4/003; H04L 67/26; G06Q 30/0601; G06F 8/30

(57) ABSTRACT

The present disclosure relates to an operation and management system providing applications for mobile devices and an electronic transaction method and an application generator thereof. The operation and management system comprises an application generator used to receive first data from a store's store end equipment and create the store's dedicated application which can be downloaded by a portable devices; the operation and management system comprises a data setter used to receive second data from the store's store end equipment and depending on the second data changeable for the dedicated application to complete configuration; the operation and management system comprises an data providing unit that is activated in the portable device, which links the operation and management system for execution of the application, and used in exporting first data and second data corresponding to the application so that transactions are completed in the operation and management system by the portable device in which the application UI is operated.

### CROSS-REFERENCE TO RELATED APPLICATIONS

This PCT application claims priority to Taiwan Patent Application No. 102218992, filed on Oct. 11, 2013, and to Taiwan Patent Application No. 102222742, filed on Dec. 4, 2013, both are pending, and both of which are hereby incorporated by reference in their entirety.

### BACKGROUND OF THE INVENTION

1. Field of the Invention

The present invention disclosure relates to an operation and management system, method thereof, and an application generator, particularly an operation and management system providing e-commercial applications on mobile devices, an electronic transaction method thereof, and an application generator.

2. Description of the Prior Art

People's consuming habits have been steering to on-line virtual shops from physical stores gradually because of Internet and shopping websites flourishing with each passing day. In recent years, the popularity of smart phones and mobile Internet makes online consumption available anytime without restriction on time or locations.

Furthermore, Application (App for short) has become a term of applications activated in portable devices popular currently such as iPhone, iPad, Android-based mobile phones, and tablet computers by which consumers download multiple applications for photographing, game, music, sport, shopping, etc. from an application store. (ex. App Store, Google Play, Windows Phone Store or BlackBerry App World)

Some on-line virtual stores create dedicated application for their stores. The applications of virtual store can be directly executed in a portable device of a consumer, and provides the consumer to make transactions with virtual store. However, the store owner needs to commission the professional or software vendor to program the application of virtual store. And the programming processing takes a lot of money and time, and affects usage intension of the store owner. Furthermore, when multiple applications are created or updated, the individual professionals or software vendors need to upload each application to the application store respectively so as to provide the consumer to download and use the new added/revised application from the application store by the portable device. However, uploading a large number of applications to the application one by one is a time-consuming job for individual professionals or software vendors.

Accordingly, developing an operation and management system for E-commercial application on mobile device which provides multiple store owner creating dedicated application, revising the content of the dedicated application, and uploading batch of the dedicated applications is a critical issue of application industry.

### SUMMARY OF THE INVENTION

In view of the prior art, the ordinary store owners do not have the ability to create his/her own application, and it's difficult for the individual professionals or the software vendors to maintain and upload batch of applications to the application store. The purpose of present invention provides an operation and management system for E-commercial application on mobile device. The operation and management system provides each store owner to easily make dedicated application, revise the content of the dedicated application, and upload batches of applications to the application store.

Accordingly, an operation and management system for E-commercial application on mobile device comprises an application generator, a data setter and a data providing unit. The application generator is used in receiving first data from store end equipment and depends on first data to create a dedicated application for the store; the data setter is used in receiving second data from store end equipment. The second data is presented as a selling content of virtual store, and can be updated by the store end equipment. The data providing unit comprises a plurality of executing contents. Each of the executing contents comprises the second data of the application. The application is executed on a portable device, which links to the operation and management system, and the data providing unit transfer the first data and the second data of the application to the portable device, and then the application of the portable device is browsed and operated by a consumer so that a transaction is completed in the operation and management system.

The operation and management system further comprises a scheduling module and an automated execution module. The scheduling module is capable of issuing a generation command with specific generation time by referring to the first data from the store end equipment. The automated execution module is able to automatically create the application, which can be uploaded to the application store and downloaded by the portable device from the application store, according to the first data when the timing of the operation and management system matches specific generation time. As such, batches of applications can be uploaded to the application store via the operation and management system.

According to abovementioned purposes, an electronic transaction method of an operation and management system providing applications for mobile devices presented herein comprises: using an application generator to receive first data from a store end equipment; using the application generator to create a dedicated application of the store based on the first data; using a data setter to receive the second data from the store end equipment; using the data setter and according the second data to configure the required content of application; when the portable device executing the application and connecting to the operation and management system, the data providing unit providing the second data of executed application and displaying on the portable device to provide the user browsing and operating the application; and making the portable device use the application to trade on the operation and management system.

According to abovementioned purposes, an application generator herein comprises a first data reception module, a profile generation module, a code acquisition module and an application setup module. The first data reception module is used in receiving data from one store end equipment of a store owner. The profile generation module depends on the first data to create an application profile dedicated to the store owner. The code acquisition module is used to receive codes for creation of a dedicated application. The application setup module depends on the application profile and the codes to create a dedicated application of the store owner.

### BRIEF DESCRIPTION OF THE DRAWINGS

The accompanying drawings which facilitate understanding of technical measures and effects of an operation and management system providing applications for mobile devices are shown as follows:

FIG. 1 is a schematic view illustrating an operation and management system.

FIG. 2 is a flow diagram illustrating an application created by an application generator in an operation and management system providing applications for mobile devices.

FIG. 3 is a schematic view illustrating an application pusher in an operation and management system providing applications for mobile devices.

FIG. 4 is a flow diagram illustrating an application generator and a data setter in an operation and management system providing applications for mobile devices.

FIG. 5 is a schematic view illustrating a first data reception module of an application generator in an operation and management system providing applications for mobile devices.

FIG. 6 is another schematic view illustrating a first data reception module of an application generator in an operation and management system providing applications for mobile devices.

FIG. 7 is a schematic view illustrating a profile generation module and an application setup module of an application generator in an operation and management system providing applications for mobile devices.

FIG. 8 is a schematic view illustrating a second data reception module of a data setter in an operation and management system providing applications for mobile devices.

FIG. 9 is another schematic view illustrating an operation and management system.

FIG. 10 is a further schematic view illustrating an operation and management system.

### DETAILED DESCRIPTION OF THE PREFERRED EMBODIMENT

An operation and management system providing applications for mobile devices will be further illustrated with embodiments as well as accompanying drawings for clear understanding of its purposes, technical measures and advantages. It should be understood the embodiments hereinafter are used to explain but not restrict an operation and management system providing applications for mobile devices. The descriptions based on embodiments and accompanying drawings are shown as follows:

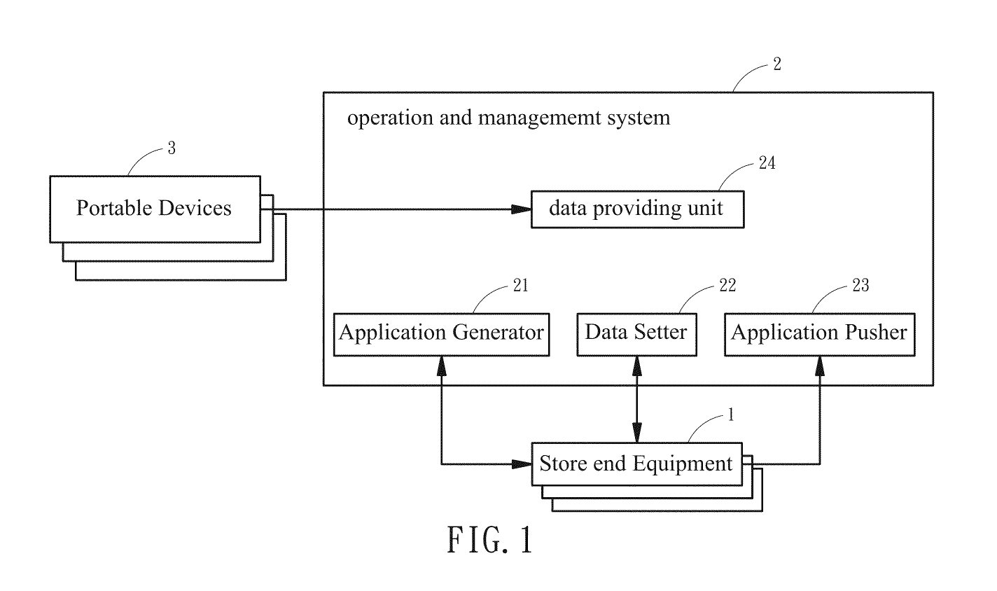

Referring to FIG. 1 which illustrates an operation and management system providing applications for mobile devices, wherein an operation and management system 2 comprises an application generator 21, a data setter 22, an application pusher 23 and a data providing unit 24.

The application generator 21 is configured to receive first data from store end equipment 1 of a store owner, and create the dedicated application of virtual store according to the first data. In present invention, the application created by the application generator 21 may be provided to the Apple's App store, Google's Google Play, Microsoft's Windows Phone Store, or BlackBerry's BlackBerry App. Each Application store is provided the portable device with compatible operation system to download the corresponding application.

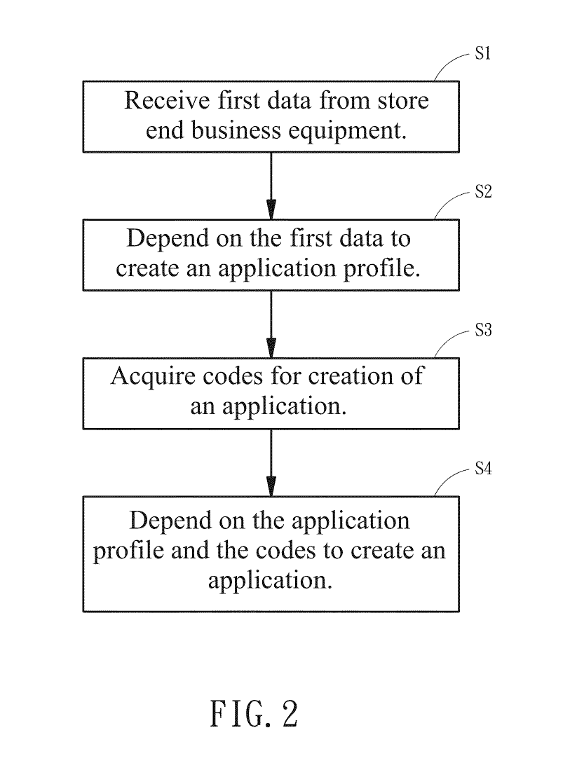

Referring to FIG. 2 which illustrates a flow diagram for an application created by an application generator based on steps as follows:

S1: Receive first data from store end equipment;

S2: Depend on the first data to create an application profile;

S3: Acquire codes for creation of an application;

S4: Depend on the application profile and the codes to create an application.

Accordingly, the application generator in the present disclosure is a tool through which the first data is uploaded and integrated with codes for creation of an application so that a store's dedicated application is quickly created without assistance of a programmer hired by the store.

The data setter 22 receives second data from store end equipment 1, the second data is presented as a selling content of virtual store, and can be updated by the store end equipment.

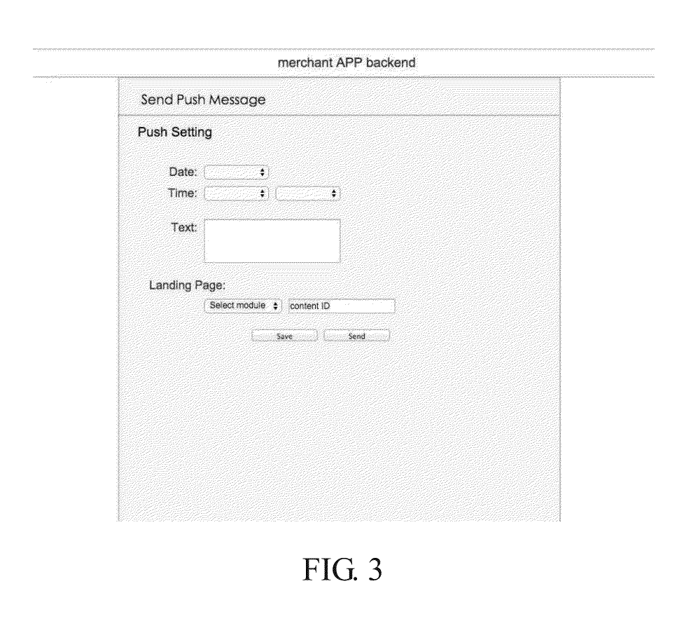

Referring to FIG. 3 which illustrates an application pusher 23 is provided the store end equipment to configure the push settings of a dedicated application, so as to provide pushing notice to the portable device 3 downloaded the application.

The data providing unit is configured to store executing content of each application. The executing content comprises the first data and the second data. When the portable device 3 executes the application and links to the operation and management system 2, the data providing unit provides the second data of executed application and displays thereon on the portable device. Then the data providing unit provides the consumer to browse and operate the application of the portable device, and makes the portable device 3 trading on the operation and management system 3 according to the browsing and operating movement.

Moreover, the store end equipment 1 can be a store owner's computer, mobile phone or other electronic devices linking and communicating with the operation and management system 2. The portable device 3 can be a consumer's mobile phone or other electronic devices linking and communicating with the operation and management system 2.

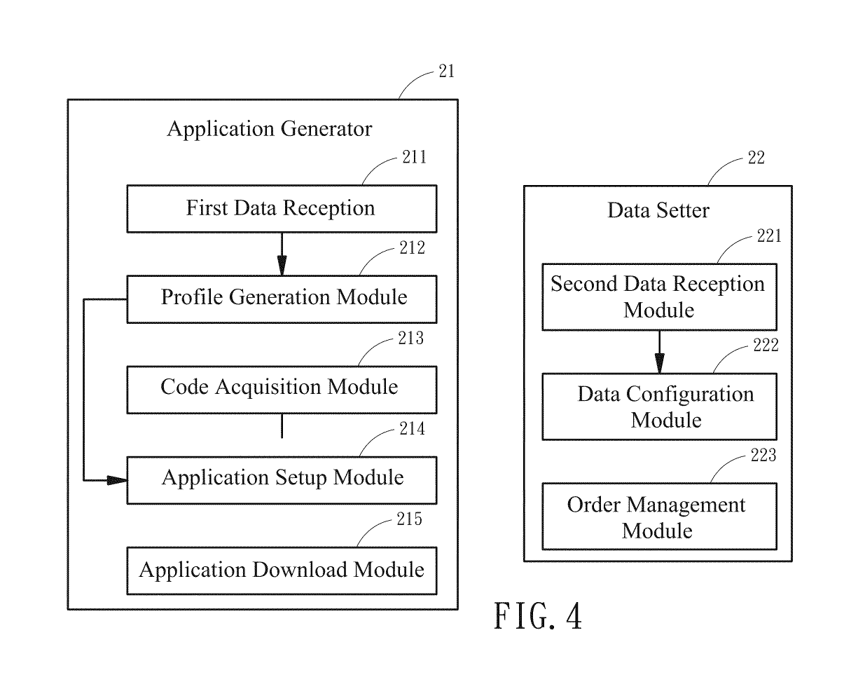

As shown in FIG. 4, the application generator 21 comprises a first data reception module 211, a profile generation module 212, a code acquisition module 213, an application setup module 214 and an application download module 215; the data setter 22 comprises a second data reception module 221, a data configuration module 222 and an order management module 223.

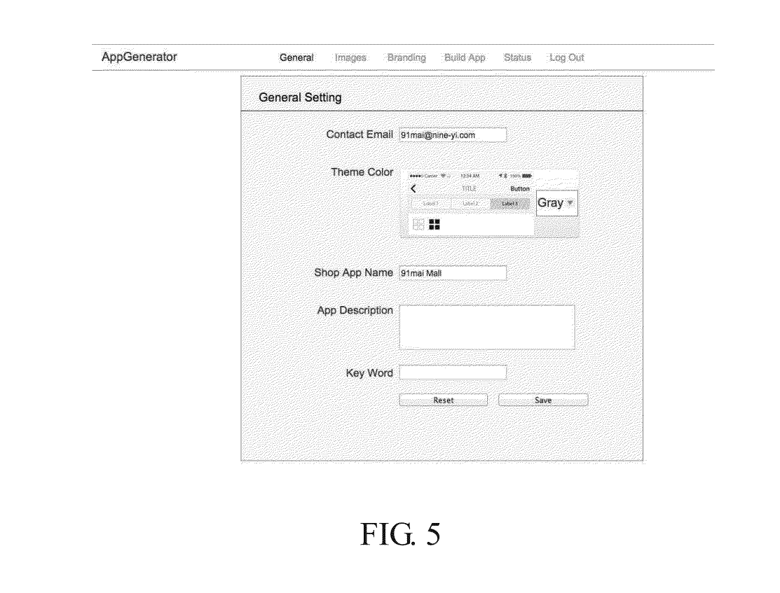

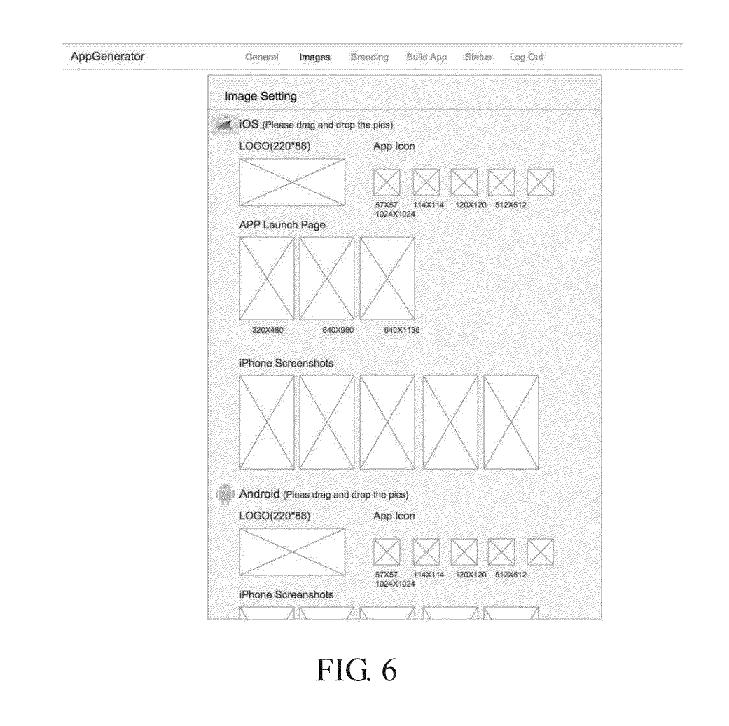

As shown in FIGS. 5 and 6, the first data reception module 211 is used in receiving the first data from the store end equipment 1. For example, the first data can be an e-mail address of the store end equipment 1, an application's theme color, time of an application to be available, an application name, a name and instructions of a store using an application, an application logo, a theme picture, an ad image, or a screenshot.

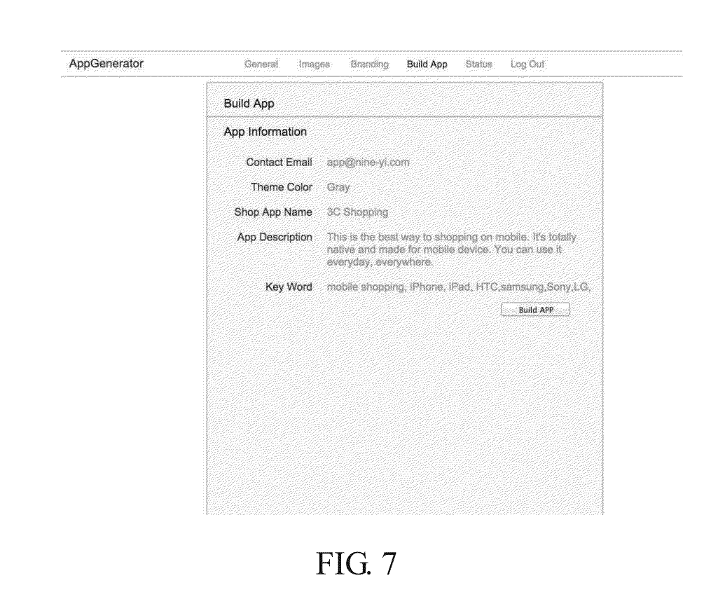

As shown in FIG. 7, the profile generation module 212 is used in creating an application profile based on the first data for the dedicated application of the store end equipment 1. Furthermore, the code acquisition module 213 is used in receiving codes to create the dedicated application of store end equipment 1. The application setup module 214 depends on the application profile and the codes to create the dedicated application of each store owner.

The application download module 215 generates a download path that the dedicated application can be downloaded and tested by the store end equipment 1. It should be mentioned the application to be downloaded to a portable device 3 should be downloaded from the application store to which the application is applicable and the application download module 215 provides the download path for the dedicated application created by the application generator 21 and tested in the store end equipment 1. Additionally, the download path can be a Uniform Resource Locator (“URL” for short) or Quick Response codes (“QR codes” for short) offered to the store end equipment 1 by e-mail, electronic message or Short Message Service (SMS).

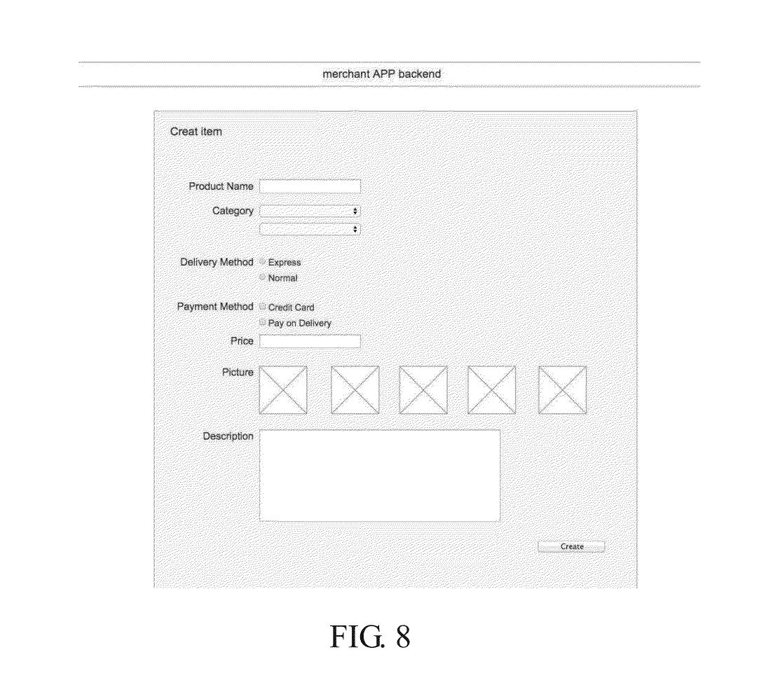

Referring to FIG. 8 which illustrates the second data reception module 221 is used in receiving second data from the store end equipment 1. For example, the second data can be commodity information, a store's image, logo, public notice, category, or activity, or a combination of any two abovementioned attributes. It should be mentioned that the store owner can login the operation and management system2 anytime to revise the first data and the second data by the store end equipment 1. And the order management module 223 is configured to manage orders produced by the trading between application on the portable device and operation and management system2

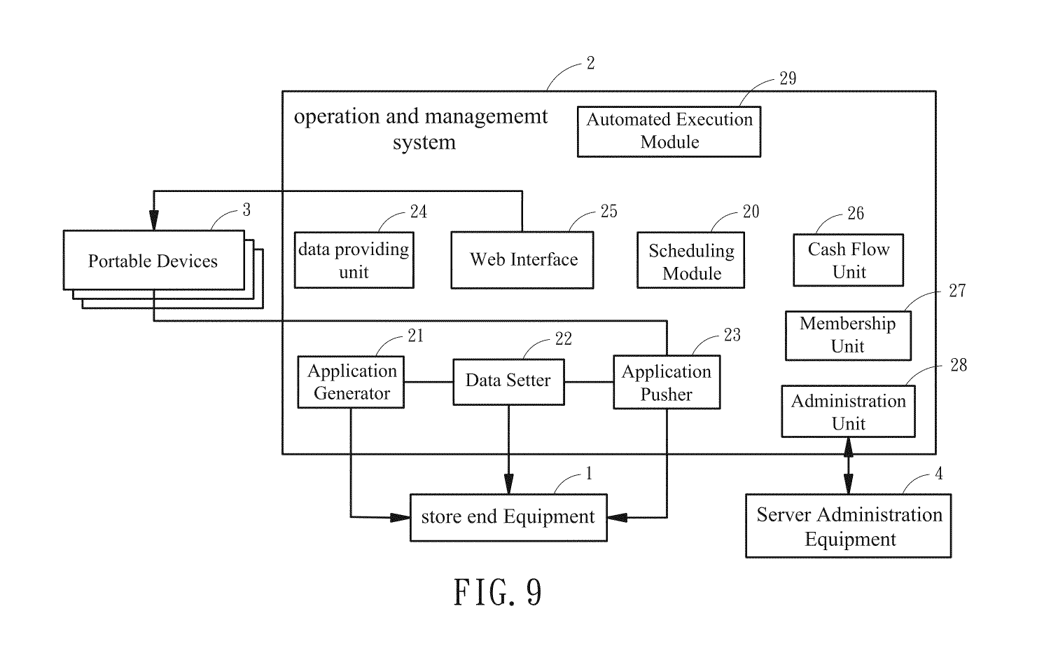

Referring to FIG. 9 which illustrates the operation and management system 2 further comprises a cash flow unit 26, a membership unit 27 and an administration unit 28. The cash flow unit 26 provides one or more portable devices 3, which are used in making transactions in the application operation and management system 2, with cash flow services. The membership unit 27 is used to register and manage membership of the one or more portable devices 3 in the application operation and management system 2. The administration unit 28 is provided to server administration equipment 4 which manages the application generator 21, the data setter 22 and the application pusher 23. The operation and management system 2 further comprises a scheduling module 20 and an automated execution module 29: the scheduling module 20 is capable of issuing a generation command with specific generation time by referring to the first data from the store end equipment 1; the automated execution module 29 is able to automatically create an application, which is uploaded to the application store and downloaded by the portable devices, according to first data when the timing of the Operation and management system 2 matches specific generation time. As such, batches of applications can be uploaded to the application store via the operation and management system 2.

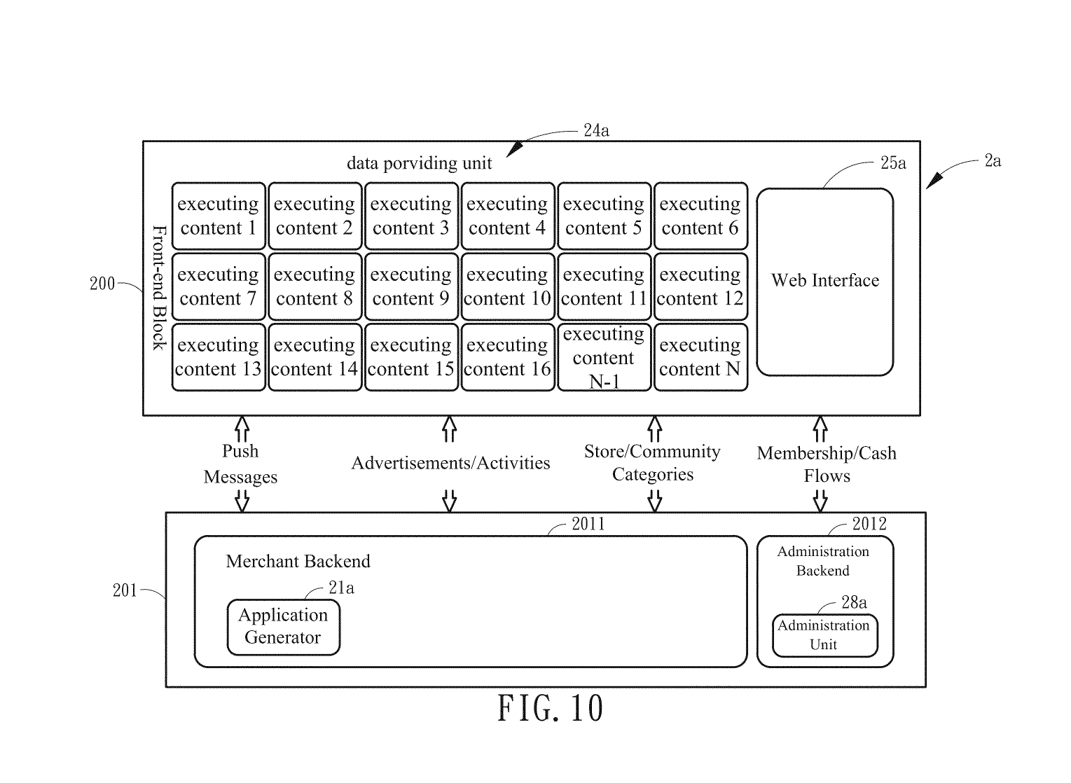

Referring to FIG. 10 which illustrates an operation and management system 2a is divided into a front-end block 200 and a backend block 201. The front-end block 200 further comprises an data providing unit 24a and a web interface 25a: the data providing unit 24a is activated on the display of the portable device 3 which links the operation and management system for execution of a corresponding application; the web interface 25a presents an ordinary on-line shopping website to be directly connected by a portable device 3 and not further described herein. In general, the operation and management system 2 provides store owners with not only a self-created application but also at least an data providing unit 24 according to first data and second data. As such, the operation and management system 2 offers the data providing unit 24a corresponding to the application which is executed in a portable device 3. Furthermore, the backend block 201 is further divided into a store backend 2011 and an administration backend 2012: the store backend 2011 comprises an application generator 21a; the administration backend 2012 comprises an administration unit 28a.

In one embodiment, the store owner uses the store end equipment to link the store backend 2011 in the backend block 201 of the operation and management system 2a, and then uses the application generator 21a to create the dedicated application. With the dedicated application created, store end equipment will receive a download path. Then, the store end equipment downloads and uses the application by the download path so as to check the application created by the application Operation and management system 2a.

A consumer is able to download the dedicated application to his/her portable device (e.g., mobile phone) from the application store, using the application in his/her portable device to activate the data providing unit 24a in the front-end block 200 of the Operation and management system 2a, browsing content through the data providing unit 24a, and making commodity transactions.

The data providing unit 24a comprises a plurality of store units. And the portable device downloads and uses different application to link the different store units of the data providing unit 24a. Because each store unit is produced by the first data and the second data of the store, the portable device can directly trade with single store in the single store unit.

Furthermore, a dedicated application which has been available already is still configured at the store backend 2011 by the store owner for some settings such as push messages, advertisements/activities, store/commodity categories, etc. Accordingly, any push message for a special promotion activity can be broadcasted by the store owner and immediately received by the portable device to which the dedicated application has been downloaded. A dedicated application and orders derived from transactions can be managed and set by the store owner through the store backend 2011 based on membership/cash flow mechanisms in the operation and management system 2a without assistance of any other mechanism. Additionally, an administrator who links the administration backend 2012 in the backend block 201 of the operation and management system 2a is able to manage the operation and management system 2a by the administration unit 28a.

In summary, the operation and management system in the present disclosure provides the store owner with service like creation of a dedicated application, which is downloaded with a portable device of a consumer who intends to browse a shop website and make transactions and used to connect the operation and management system. Therefore, the Operation and management system providing applications for mobile devices contributes to popularity of the dedicated application and consumers' shopping behaviors.

Operation and management system changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. An operation and management system for E-commercial application on mobile device, comprising:
a application generator, configured to receive first data form a store end equipment of a store, and generate a dedicated application of the store by first data; wherein, the application is uploaded to an application store and provided at least one portable device to download;
a data setter, configured to receive second data from the store end equipment of the store, and set a variable content of the application according to second data;
an data providing unit, stored an executing content of the each application;
wherein, the executing content comprises first data and second data;
wherein, when the portable device executes the application and links to the operation and management system, the data providing unit provides the second data corresponding to the application to the portable device, and displays on the portable device so as to provide a consumer browsing and operating the application on the portable device, then the portable device trades with the operation and management according to a movement of browsed and operated application.

2. The system as claimed in claim 1, wherein the application generator further comprises:
a first data reception module, configured to receive first data provided by the store end equipment;
a profile generation module, configured to depend on first data and create an application profile dedicated to the store owner;
a code acquisition module, configured to acquire needed codes to create the dedicated application;
an application setup module, configured to depend on the application profile and codes to create the dedicated application.

3. Then system as claimed in claim 1, wherein the data setter further comprises:
a second data reception module, configured to receive second data from the store end equipment;
a data configuration module, configured to base on second data and set data; and
an order management module, configured to manage orders produced by the trading between application on the portable device and the operation and management system.

4. The system as claimed in claim 1, wherein first data comprises an e-mail address of the store end equipment, an application's theme color, time of an application to be available, an application name, a name and instructions of a store using an application, an application logo, a theme picture, an ad image, or a screenshot.

5. The system as claimed in claim 1, wherein second data comprises commodity information, a store's image, logo, public notice, category, or activity.

6. The system as claimed in claim 1, further comprising:
a scheduling module, issuing a generation command with specific generation time by referring to first data from the store end equipments; and
an automated execution module, automatically creating the application, which can be uploaded to the application store and downloaded by the portable device from the application store, according to first data when the timing of the operation and management system matches the specific generation time.

7. An application generator for operation and management system, comprising:
a first data reception module, configured to receive first data from store end equipment of a store;
a profile generation module, configured to base on first data to create an application profile dedicated to the store owner;
a code acquisition module, configured to acquire needed codes to create the dedicated application; and
an application setup module, configured to depend on the application profile and codes to create the dedicated application.

8. The application generator as claimed in claim 7, wherein first data comprises an e-mail address of the store end equipment, an application's theme color, time of an application to be available, an application name, a name and instructions of a store using an application, an application logo, a theme picture, an ad image, or a screenshot.

9. An electronic transaction method on mobile device of an operation and management system, comprising:
configuring a application generator to receive first data from a store end equipment of a store;
configuring the application generator to depend on first data to create a application which dedicated to a virtual store of a store; wherein the application is provided a portable device to download;
configuring a data setter to receive second data from the store end equipment;
configuring the data setting to base on second data to provide a dedicated variable content of the application; and
configuring a data providing unit to provide needed first data and second data of the application, and configuring the portable device to base on the browsed and operated movement on the application to trade with the operation and management system.

10. The method as claimed in claim 9, wherein the application generator generates the application according following steps:
configuring a scheduling module to issue a generation command with specific generation time by referring to first data from the store end equipments;
configuring a an automated execution module basin on first data and second to create the application when the timing of the operation and management system matches the specific generation time; and
configuring the automated execution module to upload the applications to the application store and provide the portable devices download the application.
